(19) United States
(12) Patent Application Publication
(10) Pub. No.: US 2003/0179843 A1
(43) Pub. Date: Sep. 25, 2003

(54) Method for incinerating transuranian chemical elements and nuclear reactor using same

(76) Inventor: Bruno Bernardin, Provence (FR)

Correspondence Address: Thelen Reid & Priest, PO Box 640640, San Jose, CA, 65165-0640, US

(21) Appl. No.: 10/221,094

(22) PCT Filed: Mar. 6, 2001
(86) PCT No.: PCT/FR01/00656

(30) Foreign Application Priority Data
Mar. 8, 2000 (FR) 00/02958

(51) Int. Cl. G21G 1/10

(52) U.S. Cl. 376/194

(57) ABSTRACT

Incineration process for transuranic chemical elements and nuclear reactor implementing this process.

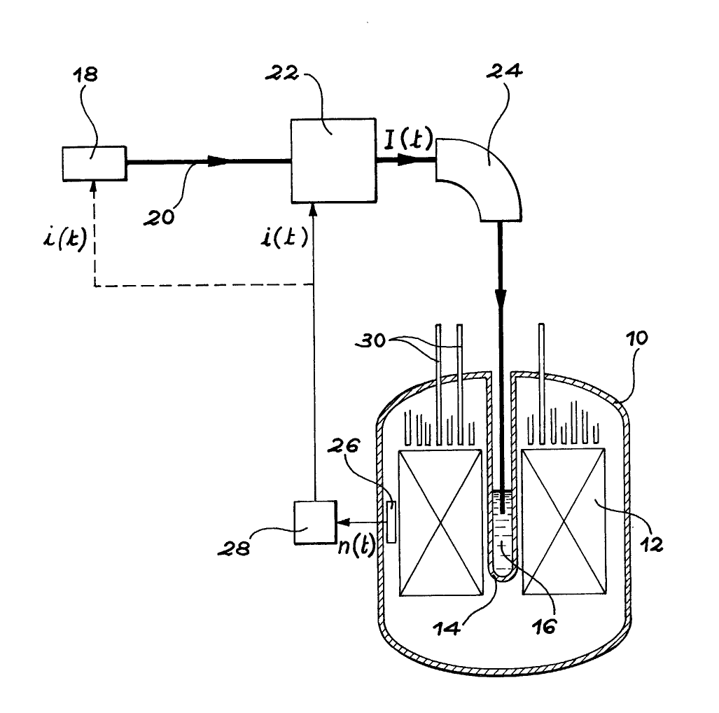

In order to incinerate transuranic chemical elements, such as long-lived nuclear waste and plutonium, a nuclear reactor is used in which the core (12) operates at a low level of sub-criticality. This level is chosen substantially equal to the difference βₛ between a desired fraction βₜ of delayed neutrons in the core and the real fraction β. An external source of spallation neutrons includes a proton accelerator in which one adjusts the power, in real time, on the neutron flux measured in the core (12). A supplementary fraction of delayed neutrons equal to the difference βₛ is thus injected into the reactor core. The reactor then behaves and controls itself like a classical critical reactor.

### TECHNICAL FIELD

The invention concerns a process that enables transuranic chemical elements to be incinerated in a nuclear reactor.

The invention also concerns a nuclear reactor implementing this process.

Among the transuranic chemical elements that may be incinerated according to the invention, long-lived nuclear waste such as the minor actinides and plutonium may, in particular, be cited.

### STATE OF THE PRIOR ART

In the nuclear industry, long-lived nuclear waste constitutes a major problem for the environment. Which is why transmuting this waste by incinerating it is being envisaged.

Among the solutions initially considered, the direct spallation of minor actinides by a particle beam and the fission of this waste by neutrons emanating directly from a spallation target may be cited for the record. However, these methods have, for the moment, been put aside because the weight incineration of waste would require, in both cases, beams of unrealistic intensity.

Another solution would be to introduce the minor actinides to be incinerated into classical nuclear reactors (pressurised water or fast neutron reactors). However, the quantity of waste introduced into each reactor would then have to be limited to around 1% of the fuel. In fact, the introduction of these elements would lead to the degradation of certain parameters that are important for the safety of the reactor and, in particular, a drop in the fraction β of delayed neutrons and in the Doppler coefficient in the reactor core. Moreover, this method would lead to a complication that would be difficult to accept for the management of the cores of the reactors concerned and lead to a significant increase in costs since it would have to apply to virtually all of the existing reactors in place.

In order to properly understand the importance of the β fraction of delayed neutrons in a nuclear reactor, it is recalled that, in a critical reactor, it is necessary for the natural period of the reactor to be greater than the time constants of the phenomena that ensure the stability of the system (thermal counter reactions, dilatations, regulation systems). However, the natural period of a critical reactor varies in the same sense as the β fraction. As a result, in this type of reactor, the fraction of delayed neutrons must also be above a minimum threshold.

Two other solutions are currently being envisaged for the incineration of nuclear waste. These are, firstly, critical reactors dedicated to this function and, secondly, sub-critical hybrid systems.

In “dedicated” critical reactors, the characteristics of the reactor such as the geometry of the core and the composition of the fuel would be modified, compared to a classical nuclear reactor, in such a way as to improve the tolerance of these reactors to a higher concentration of waste.

In practice, it is envisaged defining the core of a dedicated critical reactor after having determined, from a strictly safety point of view, the minimum value of the β fraction of delayed neutrons required for a critical reaction. One would then adjust the composition of the fuel (addition of U₂₃₅ and Th₂₃₂) and the incineration capacity, in other words the percentage of waste to introduce into the core, so that the fraction of delayed neutrons keeps within, with a suitable margin, the minimum value determined beforehand. The drop in the Doppler coefficient would be reduced, moreover, by playing on the geometry of the core and the hardness of the spectrum.

Although the development of this type of dedicated critical reactor seems possible, it would certainly be very difficult, given the problems that would need to be solved.

Moreover, even if this hurdle could be overcome, the reactor would have, in any event, a β fraction of delayed neutrons lower than that of classical fast neutron reactors, in which this fraction is already relatively low. Even if the fraction of delayed neutrons meets the safety imperatives, a dedicated critical reactor would have less safety margin than existing reactors vis-á-vis certain types of accidents. This is a not inconsiderable disadvantage for a new line of reactors.

The other solution currently being envisaged for the incineration of nuclear waste concerns the use of sub-critical hybrid systems, or “ADS” (Accelerator Driven Systems). A system of this type is described in document U.S. Pat. No. 5,774,514.

In this type of system, a sub-critical nuclear reactor is combined with an external source of neutrons comprising a spallation target placed within the reactor core. More precisely, a target in a material that is generally liquid, such as lead-bismuth, is housed in a reservoir in the shape of a thimble placed in a hollowing out formed in the reactor core. The target is bombarded with protons emitted by a source placed outside the reactor vessel. The protons are accelerated by an accelerator that is also placed outside of the vessel, so that they attain the energy necessary for the spallation of the target.

In this type of system, due to the fact that the reactor is sub-critical, there is no constraint on the β fraction of delayed neutrons. In fact, the reactor then behaves like a simple amplifier of the external source of neutrons. This constitutes, a priori, a positive aspect of this system, providing there is a sufficient sub-criticality margin to prevent, without any risk whatsoever, the reactor accidentally going into a critical state. For this reason, one generally envisages assigning an effective multiplication factor k_{eff} preferably between 0.9 and 0.95 to the reactor cores of sub-critical hybrid systems. The maximum value that must not be exceeded is evaluated at 0.98.

The efficiency of the control rods that are used in critical reactors is not sufficient to enable the control of hybrid systems with high sub-criticality levels. This function is then assured entirely by the external source of neutrons.

However, this type of sub-critical hybrid system requires an important external source of spallation neutrons. This leads to very high power and controllability requirements for the source and the proton accelerator, which in turn leads to considerably higher costs compared to an equivalent critical reactor.

Moreover, unlike critical reactors, sub-critical hybrid systems only benefit to a very small extent from the effects of the thermal counter reactions that play an important moderating role during certain types of transients. This problem is accentuated by the fact that the response time to source or reactivity variations are very short, which leads to rapid transient power variations.

Furthermore, in this type of system, there is a specific accident risk due to the injection, at the start of the cycle, of the maximum intensity of the proton beam, required at the end of the cycle.

It therefore appears that neither of the two solutions currently envisaged for incinerating nuclear waste has decisive advantages. On the contrary, both of these solutions pose problems that could turn out to be critical defects in the future.

### DESCRIPTION OF THE INVENTION

A precise aim of the invention is an incineration process that constitutes an intermediate solution between that of the dedicated critical reactor and that of the sub-critical hybrid system, wherein this solution makes it possible to resolve the safety problems linked to the drop in the fraction β of delayed neutrons in dedicated critical reactors and the problems posed, in particular, by the size of the proton source and proton accelerator in sub-critical hybrid reactors.

According to the invention, this result is obtained by an incineration process for transuranic chemical elements, in which said elements are placed in the sub-critical core of a nuclear reactor and spallation neutrons, emanating from an external source, are injected into the core, characterised in that:

a reactor is used in which the core operates at a low level of sub-criticality, substantially equal to the difference between a desired fraction βₜ of delayed neutrons in the core and a real fraction β of neutrons in the core

the instantaneous neutron flux n (t) in the core is measured.

the power of the external source is adjusted in real time, based on the measured neutron flux n (t), in such a way as to simulate the existence in the core of a supplementary group of delayed neutrons according to a fraction βₛ equal to said difference.

In other terms, the low level of the fraction β of intrinsic delayed neutrons in the reactor core, due to the presence in the core of a high proportion of transuranic chemical elements, is compensated by the fictitious addition of a supplementary group of delayed neutrons. This is achieved by making the core operate at a very low level of sub-criticality, which makes it possible to approximately simulate the fraction of delayed neutrons to add, in other words, the deficit of the fraction β that has to be compensated. The measurement, in real time, of the neutron flux n (t) makes it possible to calculate in real time the evolution in the number of fictitious precursors from the supplementary group of delayed neutrons, in such as way as to adjust, still in real time, the power of the external source. The neutrons injected into the core are then representative of the decrease in fictitious precursors from the supplementary group worked out from the calculation and make up for the deficit in neutrons caused by the sub-criticality operation mode.

The hybrid system thus constituted behaves and controls itself like a critical reactor. In fact, the counter reaction established between the external source and the neutron power, via a fictitious supplementary group of delayed neutrons, assures the stability of the very slightly sub-critical hybrid system and transforms it, in a fictitious manner, into a critical reactor with a fraction of delayed neutrons increased by βₛ.

The low level of the fraction of delayed neutrons, arising from the presence of transuranic elements in the core, is thus compensated in such a way that the safety imperatives, which would not be met in a dedicated critical reactor, are easily satisfied.

An essential advantage of the incineration process according to the invention resides in the fact that the very low level of sub-criticality of the reactor makes it possible to reduce the maximum power of the external source by a factor of 20 to 30 compared to a conventional hybrid system. Thus, by way of example, obtaining a supplementary fraction βₛ of delayed neutrons of around 300 pcm (“for one hundred thousand”), in a reactor of 3000 MW, would require a beam intensity of around 6.5 mA with protons of 1 GeV. The different elements forming the source of external neutrons, in other words the source of protons, the proton accelerator and the target, can thus have dimensions and costs that are compatible with industrial applications.

Due to the fact that the system behaves and controls itself like a critical reactor, it makes it possible to benefit from the stabilising effects of thermal counter reactions and the Doppler effect, specific to this type of reactor.

Moreover, it offers improved safety compared to an equivalent critical reactor, since it has, in addition to classical means of emergency shut down, the possibility of rapidly eliminating, in a reliable manner, an important fraction of the delayed neutrons, by cutting off the beam emitted by the external source.

Advantageously, the control of the system is assured by absorbent control rods, inserted into the core.

In practice, a reactor whose core is configured to have an effective multiplication factor k_{eff} substantially equal to 0.997 is used.

Moreover, preferably the desired fraction β_{T} of delayed neutrons is set at around 350 pcm.

The power of the external source is adjusted by acting on the proton accelerator.

In a preferred embodiment of the invention, the number Cₛ(t) of fictitious precursors from the supplementary group of delayed neutrons is determined from the measured neutron flux n(t), by applying the equation:

$$\frac{ⅆ {C}_{s} ( t )}{ⅆ t} = \frac{{β}_{s}}{\hat{}} \cdot n ( t ) - {λ}_{s} \cdot {C}_{s} \cdot ( t ) \qquad ( 1 )$$

in which:

\hat{ } represents the lifetime of the prompt neutrons, and

λₛ represents the decay constant for the fictitious precursors from the supplementary group.

The intensity I(t) of the proton beam at the exit of the proton accelerator is then regulated, by applying the equation:

I(t)=Q·λₛ·Cₛ·(t)Zφ* (2)

in which Cₛ·(t) is determined, in real time, from the equation (1), and in which:

Q represents the proton charge (1.6·10⁻¹⁹ C)

Z represents the number of neutrons produced per proton in the spallation target, and

φ* is a constant, representative of the importance of the external source of neutrons compared to the reactor core.

Preferably placed at the centre of the core, the source will have a φ* substantially equal to 1. If it was placed at the edges, its efficiency would be reduced, and this would lead to a lower φ* value.

Moreover, the value of the decay constant λₛ is consistent with the different values of λ_{I}, which depend on the nature of the precursors of delayed neutrons and not the composition of the core. This value is, preferably, around 0.08 s⁻1.

A further aim of the invention is a nuclear reactor for the incineration of transuranic chemical elements, comprising a sub-critical core, containing said elements to be incinerated, and an external source of spallation neutrons, characterised in that:

the core operates at a sub-criticality level substantially equal to the difference between a desired fraction βₜ of delayed neutrons in the core and a real fraction β of delayed neutrons in the core.

means are provided to measure, in real time, the instantaneous neutron flux (t) in the core.

means of counter reaction are provided to adjust, in real time, the power of the external source based on the measured neutron flux n(t) in such a way as to simulate the existence in the core of a supplementary group of delayed neutrons, according to a fraction βₛ equal to said difference.

### BRIEF DESCRIPTION OF THE DRAWING

A preferred embodiment of the invention will now be described by way of example and in nowise limitative, while referring to the appended drawings, in which the unique figure is a diagram that represents a nuclear reactor according to the invention.

### DETAILED DESCRIPTION OF A PREFERRED EMBODIMENT

In the unique figure, a nuclear reactor according to the invention has been represented very schematically. This reactor is intended for the incineration of transuranic chemical elements such as long-lived nuclear waste (minor actinides) and plutonium.

The reactor according to the invention is, in a general manner, like a sub-critical hybrid system. This system can take numerous forms, such as those described, for example, in document U.S. Pat. No. 5,774,514 to which the reader may refer, if necessary, for further details.

It should first of all be noted that the reactor can indifferently take on the form of a fast neutron or thermal reactor, without going beyond the scope of the invention. The values of the parameters given by way of example in this document nevertheless correspond to fast neutron reactors.

As shown very schematically in the unique figure, the reactor comprises a vessel 10 in which is placed the core 12. This core is made up, in the habitual manner, of juxtaposed vertical assemblies (not shown). The nuclear fuel is integrated into these assemblies according to techniques well known to those skilled in the art and are not part of the invention. Nevertheless, given that the reactor is dedicated to the incineration of transuranic chemical elements, these elements are introduced into the assemblies in place of part of the nuclear fuel habitually used.

According to a characteristic of the invention, the core 12 of the reactor operates at a very low level of sub-criticality. More precisely, the level of sub-criticality of the core 12 of the reactor is substantially equal to the difference between a desired fraction βₜ of delayed neutrons in the core and the real fraction β.

The real fraction β depends on the nature of the elements contained in the core. Due to the presence of transuranic chemical elements, the real fraction β of delayed neutrons is very low, for example close to 100 pcm.

The desired fraction βₜ is chosen arbitrarily, so that the reactor operates under safety conditions comparable to those of critical reactors currently in service. Thus, a value comparable to the fraction of delayed neutrons present in a fast neutron reactor is assigned to βₜ, in other words around 350 pcm.

The comparison of the values given above, by way of a preferential example, leads to assigning a value of around 250 to 300 pcm to the level of sub-criticality. This value, corresponding to the fraction βₛ, is introduced into the equation (1). The effective multiplication factor k_{eff} of the reactor core is substantially equal to 0.997.

It should be noted that the level of sub-criticality of the core and its translation in terms of effective multiplication factor k_{eff} are determined by the position of the control rods, which is itself determined by obtaining the critical state for the system as a whole.

The core 12 of the reactor has, at least on one part of its height, an annular form centred on a vertical axis.

A tube 14, in the form of a thimble, penetrates into the vessel 10 along the vertical axis of the core 12, in such way that its closed end is situated in the shaft going through the core. The opposite end of the tube, such that its upper end in the embodiment illustrated by way of example in the figure, crosses through the vessel in a leaktight manner.

It should be noted that the other components of the reactor, such as the pumps and the heat exchangers habitually placed within the vessel 10, have been voluntarily omitted so as not to overcrowd the figure. It goes without saying that, in practice, these components that are well known to those skilled in the art will be present, in the same way as the coolant, such as water, sodium or a neutral gas, depending on the type of reactor.

The closed end of the tube 14, placed in the shaft crossing the core, contains a spallation target 16. This target, generally liquid, is composed of any material that can emit spallation neutrons when it is bombarded by a proton beam with the required energy. By way of example and in nowise limitative, the target 16 may in particular be made out of lead-bismuth. Means (not shown) are habitually provided, in a manner known to those skilled in the art, to ensure the fusion of the target before the start up of the reactor and its cooling in operation.

A source of protons 18, placed outside the vessel 10 of the reactor, emits a proton beam 20. This proton beam is accelerated by a proton accelerator 22, then guided towards the target 16, for example by means of deflection 24, which direct the accelerated beam along the vertical axis of the tube 14. The source of protons 18, the proton accelerator 22 and the target 16 together form an external source of spallation neutrons, vis-à-vis the core of the reactor.

The source of protons 18, the accelerator 22 and the means of deflection 24 may be constructed in any way, by using techniques known to those skilled in the art. In accordance with the invention, the source 18, the accelerator 22 and the target 16 have, nevertheless, characteristics such that the maximum power is reduced by a factor of 20 to 30 compared to classical hybrid systems. This makes it possible to use much smaller components, particularly as regards the accelerator 22.

In accordance with the invention, the reactor comprises, in addition, means 26 for measuring, in real time, the instantaneous neutron flow n(t) in the core 12 of the reactor, as well as means of counter reaction 28, to adjust in real time the power of the external source of spallation neutrons.

The means 26 for measuring the instantaneous neutron flow in the core comprise neutron measurement sensors well known to those skilled in the art, if necessary supplemented by associated electronic circuits.

The means of counter reaction 28 comprise a calculator that receives the signal n(t) delivered by the means 26 for measuring the neutron flux and delivers a signal i(t). This signal i(t) is an electric signal that is applied to the terminals of the accelerator 22 in such a way as to deliver, at the exit of this accelerator, a beam of protons with intensity I(t) calculated by the calculator integrated into the means of counter reaction 28.

According to the invention, the signal i(t) is calculated in real time, in such a way as to simulate the existence, in the core, of a supplementary group of delayed neutrons, of which the fraction βₛ added to the real or intrinsic fraction β of delayed neutrons in the core leads to obtaining in the core the desired fraction βₜ. The fraction βₛ thus calculated is substantially equal to the level of sub-criticality that has moreover been chosen for the reactor. In this way, the sub-critical hybrid reactor is “transformed” into a critical reactor.

The calculation of the signal i(t) is broken down into two operations: the determination of the number Cₛ (t) of fictitious precursors from the supplementary group of delayed neutrons, from the signal n(t) delivered by the means 26 for measuring the neutron flux in the core, then the calculation of the electric signal i(t) to apply to the source 18 and/or the accelerator 22, in order to obtain the Cₛ(t) of fictitious precursors determined previously.

The number Cₛ(t) of fictitious precursors from the supplementary group of delayed neutrons is determined from the equation:

$$\frac{ⅆ {C}_{s} ( t )}{ⅆ t} = \frac{{β}_{s}}{\hat{}} \cdot n ( t ) - {λ}_{s} \cdot {C}_{s} \cdot ( t ) \qquad ( 1 )$$

in which:

\hat{ } represents the lifetime of the prompt neutrons, and

λₛ represents the decay constant for the fictitious precursors from the supplementary group of delayed neutrons.

The value of the fraction βₛ is chosen to obtain the desired β_{T}, given the intrinsic β of the core. The level of sub-criticality in the core, obtained in operation, will automatically equal this value.

The value of λₛ is chosen in such a way as to be consistent with the different values of the decay constants of the precursors of delayed neutrons in the core. It is, for example, around 0.08 s⁻¹.

The means of counter reaction 28 then calculate the value of the electric signal i(t) to apply to the source 18 and/or the accelerator 22, so that the delayed neutrons injected into the core of the reactor by the external source are representative of the number Cₛ(t) of fictitious precursors calculated in real time (t designates the time). This calculation is made, also in real time, using the equation:

I(t)=Q−λₛ·Cₛ·(t)Zφ* (2)

in which:

Q represents the proton charge (1.6·10⁻¹⁹ C)

Z represents the number of neutrons produced per proton in the spallation target 16, and

φ* is a constant, representative of the importance of the external source compared to the reactor core.

For a given spallation target, the value of Z is known to those skilled in the art. By way of indication, this value is equal to 30 in the case of a lead target associated with protons at 1 GeV.

After having calculated the intensity I(t) of the proton beam to obtain at the exit of the accelerator 22, the means of counter reaction 28 then determine the intensity i(t) of the electric signal controlling the accelerator by using a third equation, specific to the accelerator 22 used, linking the intensity i(t) of the electric control signal to the intensity I(t) of the delivered proton beam.

Thanks to the counter reaction effect thus obtained between the neutron power in the core and the external source, a reactor is formed that behaves as if it had a supplementary source of delayed neutrons within the interior itself of the core. A hybrid system is thus transformed into a critical reactor with a fraction β of delayed neutrons increased by a value βₛ. This value βₛ is chosen, in the same way as the value for the decay constant λₛ for the fictitious precursors from the supplementary group, in such a way as to bring the total value βₜ of delayed neutrons in the core to a desired value. As has already been indicated, this desired value is equal, preferably, to around 350 pcm in order to satisfy, from this point of view, the safety requirements in conditions that are comparable to those of existing nuclear reactors.

The reactor according to the invention thus behaves and controls itself like a classical critical reactor, by acting on the reactivity. To this end, it is equipped with control rods 30, as shown schematically in the unique figure.

The operation of the reactor according to the invention meets the following kinetic equations of the punctual model:

$$\begin{matrix}\frac{ⅆ n ( t )}{ⅆ t} = \frac{{ρ}^{′} - {β}_{s} - β}{\hat{}} \cdot n ( t ) + λC ( t ) + {λ}_{s} \cdot {C}_{s} \cdot ( t ) + {q}_{0} \\ \frac{ⅆ C ( t )}{ⅆ t} = \frac{β}{\hat{}} \cdot n ( t ) - λC ( t ) \\ \frac{ⅆ {C}_{s} ( t )}{ⅆ t} = \frac{{β}_{s}}{\hat{}} \cdot n ( t ) - {λ}_{s} \cdot {C}_{s} \cdot ( t )\end{matrix}$$

in which:

ρ′ represents the overall reactivity of the reactor

C(t) represents the number of real precursors of delayed neutrons in the core

λ represents the decay constant of these real precursors, and

qₒ represents the number of neutrons emitted by the inherent source to the reactor (this value becomes negligible as soon as the neutron power exceeds several hundred watts).

The above equations are representative of a system that becomes critical when ρ′ tends towards zero and has a supplementary group of delayed neutrons comprising the spallation neutrons emitted by the target 16.

The nuclear reactor according to the invention thus constitutes an intermediate solution between the dedicated critical reactor and the sub-critical hybrid reactor, in order to ensure the incineration of transuranic chemical elements. This intermediate solution resolves the principal problems posed by the two types of reactors envisaged up to now to carry out this function.

Thus, thanks to the addition of a supplementary group of delayed neutrons, the reactor according to the invention avoids the problems of safety posed by classical critical reactors when it is envisaged using them to incinerate transuranic chemical elements. In fact, the reduction in the fraction of delayed neutrons, due to the presence of these elements in the core, is compensated by the supplementary delayed neutrons simulated and injected by the external source.

Furthermore, the “transformation” of the hybrid system into a critical reactor assured by the means of counter reaction 28 means that it is possible to operate the core at a low level of sub-criticality. This makes it possible to reduce by a factor of 20 to 30 the power of the external source and, as a consequence, allows the external source and, in particular, the accelerator 22 to have a size and cost that is compatible with an industrial application.

Due to the fact that the behaviour of the reactor according to the invention is analogous to that of a classical critical reactor, it may be designed to meet all of the habitual requirements as regards safety. From this point of view, it should be pointed out that the means of measurement 26 and the means of counter reaction 28 are, preferably, fail safe in order to eliminate any risk of loss of control of the external source.

From the point of view of safety, the reactor according to the invention even has additional advantages compared to classical critical reactors.

Thus, it is possible to cut the beam of protons during an emergency stop. The effect of this action is in addition to that of the lowering of the control rods 30. The extinction of the neutron population is thus accelerated by instantaneously wiping out an important part of the precursors of delayed neutrons.

Moreover, it is possible to supply electrical power to the accelerator 22 by using the energy produced by the reactor. An automatic shut down of the system is then assured in the case of failure in the primary output of the reactor.

Obviously, the invention is not limited to the embodiment that has been described by way of example. Thus, besides the fact that the reactor may be of any type (pressurised water, fast neutrons, etc.), the characteristics such as the form of the core, the nature of the primary fluid, the siting and the nature of the spallation target, the nature of the proton source and accelerator, the trajectory followed by the proton beam, etc. may be different to those that have been described, without going beyond the scope of the invention.

1. Incineration process for transuranic chemical elements, in which said elements are placed in the sub-critical core (12) of a nuclear reactor and spallation neutrons, emanating from an external source (16, 18, 22), are injected into the core (12), characterised in that:
a reactor is used in which the core (12) operates at a level of sub-criticality substantially equal to the difference between a desired fraction βₜ of delayed neutrons in the core (12) and a real fraction β of delayed neutrons in the core (12).
the instantaneous neutron flux n(t) in the core is measured.
the power of the external source (16, 18, 22) is adjusted in real time, based on the measured neutron flux n(t), in such a way as to simulate the existence in the core of a supplementary group of delayed neutrons according to a fraction βₛ equal to said difference.

2. Process according to claim 1, in which a reactor whose effective multiplication factor k_{eff} is substantially equal to 0.997 is used.

3. Process according to either of claims 1 or 2, in which the desired fraction β_{T} of delayed neutrons is set at around 350 pcm.

4. Process according to any of the previous claims, in which an external source including a source of protons (18), a proton accelerator (22) and a spallation target (16) is used, and the power of said external source is adjusted by acting on the proton accelerator (22).

5. Process according to any of the previous claims, in which the power of the external source is adjusted by calculating the number Cₛ(t) of fictitious precursors from the supplementary group of delayed neutrons according to the equation (1):
$$\frac{ⅆ {C}_{s} ( t )}{ⅆ t} = \frac{{β}_{s}}{\hat{}} \cdot n ( t ) - {λ}_{s} \cdot {C}_{s} \cdot ( t ) \qquad ( 1 )$$
in which:
\hat{ } represents the lifetime of the prompt neutrons, and
λₛ represents the decay constant for the fictitious precursors from the supplementary group.

6. Process according to claims 4 and 5 combined, in which the intensity I(t) of the proton beam at the exit of the proton accelerator (22) is adjusted in real time, by applying the equation (2):
I(t)=Q−λₛ·Cₛ·(t)Zφ*
in which:
Q represents the proton charge (1.6·10⁻¹⁹ C)
Z represents the number of neutrons produced per proton in the spallation target (16), and
φ* is a constant, representative of the importance of the external source (16, 18, 22) compared to the reactor core.

7. Process according to claim 6, in which φ* is substantially equal to 1.

8. Process according to any of claims 5 to 7, in which λₛ is substantially equal to 0.8 s⁻¹.

9. Process according to any of the previous claims, in which the reactor is controlled by means of control rods (30) inserted into the core (12).

10. Nuclear reactor for the incineration of transuranic chemical elements, comprising a sub-critical core (12), containing said elements to be incinerated, and an external source (16, 18, 22) of spallation neutrons, characterised in that:
the core (12) functions at a sub-criticality level substantially equal to the difference between a desired fraction βₜ of delayed neutrons in the core (12) and a real fraction β of delayed neutrons in the core (12).
means (26) are provided for measuring, in real time, the instantaneous neutron flux n(t) in the core.
means of counter reaction (28) are provided to adjust, in real time, the power of the external source (16, 18, 22) based on the measured neutron flux n(t) in such a way as to simulate the existence in the core (12) of a supplementary group of delayed neutrons, according to a fraction βₛ equal to said difference.

11. Nuclear reactor according to claim 10, in which the effective multiplication factor k_{eff} is substantially equal to 0.997.

12. Nuclear reactor according to either of claims 10 or 11, in which the desired fraction β_{T} of delayed neutrons is substantially equal to 350 pcm.

13. Nuclear reactor according to any of claims 10 to 12, in which the external source comprises a proton source (18), a proton accelerator (22) and a spallation target (16), and in which the means of counter reaction (28) act on the proton accelerator (22).

14. Nuclear reactor according to any of claims 10 to 13, in which the means of counter reaction (28) comprise means suited to calculating the number Cₛ (t) of fictitious precursors from the supplementary group of delayed neutrons, according to the equation (1):
$$\frac{ⅆ {C}_{s} ( t )}{ⅆ t} = \frac{{β}_{s}}{⋀} \cdot n ( t ) - {λ}_{s} \cdot {C}_{s} \cdot ( t )$$
in which:
\hat{ } represents the lifetime of the prompt neutrons, and
λₛ represents the decay constant for the fictitious precursors from the supplementary group.

15. Nuclear reactor according to claims 13 and 14 combined, in which the means of counter reaction (28) regulate the intensity I(t) of the proton beam emanating from the proton accelerator (22), according to the equation (2):
I(t)=Q−λₛ·Cₛ. (t)Z φ*
in which:
Q represents the proton charge (1.6·10⁻¹⁹ C)
Z represents the number of neutrons produced per proton in the spallation target (16), and
φ* is a constant, representative of the importance of the external source compared to the reactor core.

16. Nuclear reactor according to claim 15, in which φ* is substantially equal to 1.

17. Nuclear reactor according to any of claims 14 to 16, in which λₛ is substantially equal to 0.08 s⁻¹.

18. Nuclear reactor according to any of claims 10 to 17, in which the control rods (30) are inserted into the core (12).
